(19) United States
(12) Patent Application Publication
(10) Pub. No.: US 2025/0304003 A1
(43) Pub. Date: Oct. 2, 2025

(54) CONNECTED VEHICLE FACTOR AUTHENTICATION

(71) Applicant: FCA US LLC, Auburn Hills, MI (US)

(72) Inventors: Lucas J Romero, St. Clair Shores, MI (US); Andrew Hoin, Auburn Hills, MI (US)

(21) Appl. No.: 18/619,533

(22) Filed: Mar. 28, 2024

(51) Int. Cl. B60R 25/20; B60K 35/28; B60R 25/40

(52) U.S. Cl. CPC B60R 25/20; B60K 35/28; B60R 25/40

(57) ABSTRACT

A factor authentication system for a vehicle having a vehicle display, a telematics device, and a vehicle controller includes a backend server configured to communicate with the vehicle and a user electronic device via a network. The backend server is configured to receive a request from the user electronic device to link the vehicle to a use case, generate one or more random questions about vehicle signals that are visible on the vehicle display, send the one or more random questions to the user electronic device, receive, from the user electronic device, user answers to the one or more random vehicle signal questions, send the user answers to the vehicle controller; and receive, from the vehicle controller, confirmation that the user answers are correct based on a comparison to local vehicle data, to thereby authenticate the vehicle and authorize the link to the use case.

### FIELD

The present application relates generally to vehicle management systems and, more particularly, to vehicle authentication systems.

### BACKGROUND

Modern vehicles are connected to various communications networks such as, for example, satellite networks, cellular networks, or computing networks. Such communications networks enable the vehicle to provide capabilities to improve driving and various vehicle operations. However, connected vehicles often generate data signals related to the vehicle status, location, etc. that could potentially reveal sensitive information about the driver if accessed by unauthorized parties. Accordingly, while such systems do work well for their intended purpose, there remains a desire for improvement in the relevant art.

### SUMMARY

In accordance with one example aspect of the invention, a factor authentication system for a vehicle having a vehicle display, a telematics device, and a vehicle controller is provided. In one example, the system includes a backend server configured to communicate with the vehicle and a user electronic device via a network. The backend server is configured to receive a request from the user electronic device to link the vehicle to a use case, generate one or more random questions about vehicle signals that are visible on the vehicle display, send the one or more random questions to the user electronic device, receive, from the user electronic device, user answers to the one or more random vehicle signal questions, send the user answers to the vehicle controller; and receive, from the vehicle controller, confirmation that the user answers are correct based on a comparison to local vehicle data, to thereby authenticate the vehicle and authorize the link to the use case.

In addition to the foregoing, the described vehicle factor authentication system may include one or more of the following features: wherein when the vehicle controller confirms the user answers, the vehicle controller sends a signal to the backend server indicating whether each of the user answers is correct or incorrect, without sending any sensitive vehicle data to the backend server; wherein the backend server sends the user answers to the vehicle controller along with a unique code; wherein if the vehicle controller confirms the user answer as correct, a notification is displayed to the user requesting the unique code; wherein the notification is displayed on the vehicle display; and wherein the notification is displayed on the user electronic device.

In addition to the foregoing, the described vehicle factor authentication system may include one or more of the following features: wherein the vehicle signals are at least one of (i) an odometer reading, (ii) a vehicle tire pressure, or (iii) a vehicle range; wherein the vehicle signals include all of (i) an odometer reading, (ii) a vehicle tire pressure, and (iii) a vehicle range; wherein the vehicle signals are chosen from the group: (i) a vehicle tire pressure, (ii) a battery voltage, (iii) a range to empty, (iv) an oil life, and (v) an odometer reading; and wherein the vehicle signals are chosen from the group: (i) a vehicle tire pressure, (ii) a battery voltage, (iii) a high voltage battery state of charge, (iv) a total range, and (v) an odometer reading.

In accordance with another example aspect of the invention, a computer-implemented method for computer-implemented method for factor authenticating a vehicle for linking to a use case is provided. In one example, the vehicle includes a vehicle display, a telematics device, and a vehicle controller having one or more processors and a non-transitory computer-readable storage medium.

In the described example, the method includes receiving, from a user channel and at a backend server, a user request to link the vehicle to the use case; generating, at the backend server, one or more random questions about vehicle signals that are visible on the vehicle display; sending, by the backend server, the one or more random vehicle signal questions to the user channel; receiving, from the user channel and at the backend server, user provided answers to the one or more random vehicle signal questions; sending, from the backend server, the user provided answers to the vehicle controller; and validating the user provided answers, by the vehicle controller, based on a comparison to local vehicle data, to thereby authenticate the vehicle and link to the use case.

In addition to the foregoing, the described method may include one or more of the following features: wherein when the vehicle controller validates the user provided answers, the vehicle controller sends a signal to the backend server indicating whether each of the user answers is correct or incorrect, without sending any sensitive vehicle data to the backend server; sending, by the backend server, a unique code with the user provided answers; displaying, by the vehicle controller or the backend server, a notification requesting the unique code; and wherein the notification is displayed on the vehicle display by the vehicle controller.

In addition to the foregoing, the described method may include one or more of the following features: wherein the notification is displayed on the user channel based on a signal from the backend server; wherein the vehicle signals are at least one of (i) an odometer reading, (ii) a vehicle tire pressure, or (iii) a vehicle range; wherein the vehicle signals include all of (i) an odometer reading, (ii) a vehicle tire pressure, and (iii) a vehicle range; and wherein the vehicle must be on in order to initiate the vehicle factor authentication system.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is schematic diagram of an example vehicle authentication system in accordance with the principles of the present application; and

FIG. 2 is a flow diagram illustrating an example method of factor authenticating a vehicle, in accordance with the principles of the present application.

### DETAILED DESCRIPTION

As previously discussed, network connected vehicles generate various data signals that may contain sensitive information if accessed by unauthorized parties. Accordingly, it is desirable to link drivers to their vehicles for certain features or services, without compromising privacy by transmitting actual vehicle data externally.

Previous solutions include linking vehicles and drivers through backend services using static identifiers like the vehicle identification number (VIN). While simple, this approach potentially lacks protections for user privacy, since the VIN or other IDs can be used to track vehicles and access data without validating if the user has physical access to the vehicle. More secure methods like challenge-response approaches have been explored, but have thus far been difficult to implement. Thus, prior solutions have primarily relied on simple static IDs, which do not confirm physical vehicle access.

Accordingly, systems and methods are provided herein for securely authenticating vehicle ownership/access in order to link/associate/connect the vehicle with a use case, such as a user account or vehicle feature/service. Through a user channel (e.g., on a portable electronic device), the system verifies that a user has physical access to the vehicle and securely links the vehicle for ownership confirmation or features enablement without ever collecting data from the vehicle. Advantageously, this vehicle factor authentication may be performed even on vehicles that have not opted for data collection.

In general, the system uses vehicle signals as a multifactor authentication method without sending data to the cloud and while maintaining data privacy standards. In one example, a user initiates a process to link the vehicle with a use case after starting the ignition. To confirm the user has access/ownership of the vehicle, the user answers one or more randomized questions about vehicle signals that are visible to the user (e.g., tire pressure, MPG data, odometer reading, etc.). The entries are validated locally on the vehicle and once confirmed, a code (e.g., a pin) is displayed on the infotainment screen. The code is then entered on a user channel and validated against what was sent. Thus, the system further authenticates a vehicle and links the vehicle to the use case using onboard signals without sensitive data ever leaving the vehicle.

In another example, the user initiates the link/connection to the vehicle via a user channel (e.g., web/mobile application). The user will answer a plurality of randomized questions on vehicle signals that are visible to the user. Example questions include: What is the current odometer reading? What is the tire pressure of the front right tire? And what is your current MPG?

The answers to these questions are sent to the cloud backend where the answer values are packaged in a vehicle policy along with a code or pin. The policy is sent down to the vehicle and the user entered values are checked against the values on the vehicle locally. Advantageously, no data is sent back to the cloud backend. If the vehicle values match the user entered values, a notification (e.g., popup) is triggered, and the code/pin is shown on the vehicle head unit. The user then enters the code/pin on the user channel and checks against the value the server sent. If they match, a link can be established for whatever the use case needs.

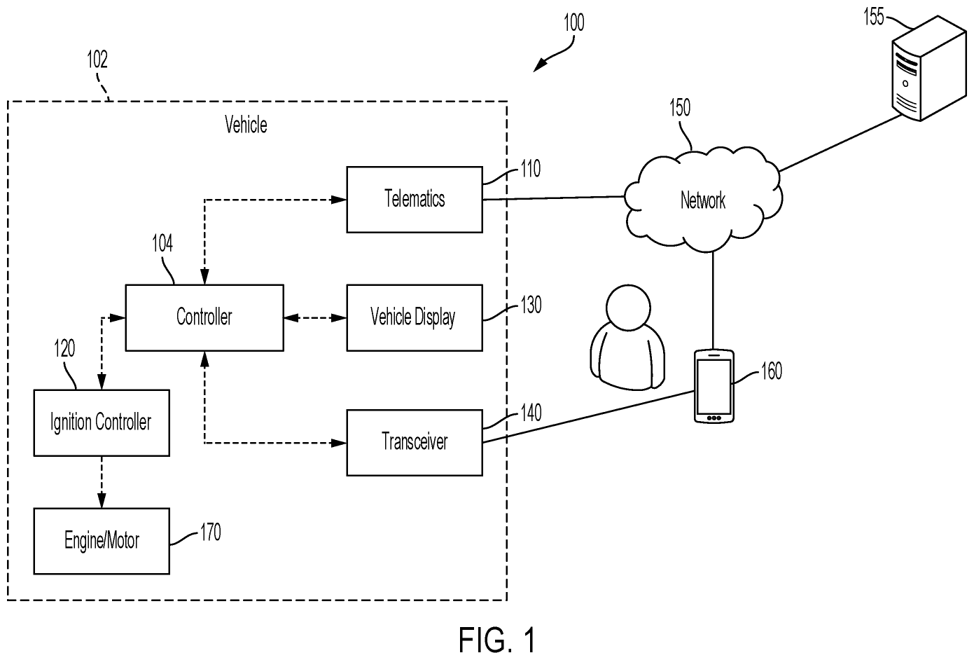

With reference now to FIG. 1, an example vehicle authentication system 100 is illustrated in accordance with the principles of the present disclosure. In the example embodiment, the vehicle authentication system 100 is generally intended for authentication and establishing a secure link/association to a vehicle 102 and will be described as such. However, it will be appreciated that vehicle authentication system 100 is not limited thereto and may be utilized with other vehicle features or authentication targets such as buildings, gates, doors, or other areas or objects where restricted access and data privacy are desired.

In the example embodiment, vehicle authentication system 100 generally includes a computing device or controller 104 (e.g., ECU) in signal communication with a telematics device 110, an ignition controller 120, one or more vehicle displays 130, and optionally a wireless transceiver 140. The controller 104 includes a processor and a memory and may be separate from or part of the telematics device 110.

The telematics device 110 is a device designed to ensure the wireless connectivity of the vehicle 102 and enables the exchange of data with external infrastructure such as a network 150 and a portable electronic device 160 (e.g., smart phone, laptop computer, tablet computer, etc.). The network 150 can be any suitable communication network including, for example, a satellite network, a cellular network (3G, 4G LTE, 5G, etc.), a computing network (local area network, the internet, etc.), or some combination thereof. The network 150 is connected to a secure backend server 155 that includes one or more secure servers, which for example, are owned and operated by a particular vehicle original equipment manufacturer (OEM) and are only accessible to authorized users, such as through a vehicle access application for device 160.

In the example embodiment, the ignition controller 120 is configured to start a vehicle engine or motor 170 based on one or more signals from the controller 104. The vehicle display 130 is a user interface such as, for example, an infotainment system having a display (e.g., a touchscreen), an instrument panel cluster, and/or other screen/display configured to display vehicle information. The wireless transceiver 140 (e.g., Bluetooth, Wi-Fi, etc.) is configured for detection of and communication with the electronic device 160 when paired with the vehicle 102. The controller 104 is configured to transmit a continuous signal (e.g., Bluetooth signal) a predefined distance (e.g., five meters) via the transceiver 140. When the paired electronic device 160 comes within the predefined distance and receives the signal, the electronic device 160 is activated and responds back to the vehicle 102 via the transceiver 140 with a response signal acknowledging its presence in the vehicle vicinity.

In the example embodiment, the portable electronic device 160 is a computing device that includes a communication device (e.g., transceiver), a processor, a memory, and a display (not shown). The electronic device 160 is configured for communication via the network 150, and the processor is configured to control operation thereof. The term “processor” as used herein can refer to both a single processor and two or more processors operating in a parallel or distributed architecture. The memory can be any suitable storage medium (flash, hard disk, etc.) configured to store information at electronic device 160. In one implementation, the memory is a non-transitory computer-readable storage medium configured to store instructions executable by the processor to cause the electronic device 160 to perform at least a portion of the disclosed techniques. The display may be a touchscreen display configured to display one or more soft buttons (not shown) to facilitate performing at least a portion of the disclosed techniques. Moreover, the electronic device 160 is capable of installing and executing instructions from one or more computer applications.

As described herein in the example embodiment, the vehicle authentication system 100 is configured to perform a “Connected Vehicle Factor Authentication” (e.g., authentication process) to validate that the user is the owner of (or has authorized possession of) the vehicle 102. The authentication process begins when a user requests vehicle authentication via electronic device 160 for a use case such as, for example, to enroll a new vehicle with a manufacturer program (e.g., a phone app) and link it with a personal account. The authentication process may be performed via one or more user channels such as, for example, a mobile app, web-based internet, a phone call, SMS, chat, etc. In some examples, the authentication process may not be initiated until the ignition controller 120 starts engine/motor 170.

To authenticate vehicle ownership, the user is queried via the electronic device 160 to answer one or more questions related to vehicle information that only a user with vehicle access and physical presence can answer. The vehicle information may be based on one or more vehicle signals such as, for example, vehicle tire PSI (left/right front, left/right rear), battery voltage, range to empty, oil life, odometer reading, seat sensor, occupancy sensor, electric range, high voltage battery state of charge, driver seatbelt, passenger seatbelt, DEF level, and total range. However, it will be appreciated that vehicle authentication system 100 may use any suitable vehicle signal/information available to confirm vehicle access and physical presence. In the example embodiment, the vehicle information is displayed on the vehicle display 130 such that the user may readily obtain the information.

Once the user answers the question(s) with the requested vehicle information (e.g., odometer reading), the backend server 155 queries the vehicle 102 to confirm the user provided answer value is correct. The vehicle 102 then evaluates the user provided answer value locally onboard and simply provides a positive/negative response to the backend server 155 whether the user provided answer was correct or incorrect. Advantageously, sensitive vehicle information is never sent from the vehicle 102 to the network 150, but rather only a simple positive/negative response.

Once the vehicle authentication system 100 validates/authenticates the vehicle 102 via the connected vehicle factor authentication, the system may then securely link/associate the vehicle 102 with a user for ownership validation or to activate/enable a vehicle feature. Advantageously, the authentication and linking operations are performed using onboard vehicle signals without potentially sensitive data ever leaving the vehicle.

In one example operation, the controller 104 is configured to receive a user request to link/associate with the vehicle 102. The ability to send or receive the user request may be conditioned upon the ignition controller 120 starting the engine/motor 170 such that the vehicle is powered on and is able to display information on the vehicle displays 130. This also proves, at least in part, that the user has authorized access to the vehicle (e.g., a key to turn the vehicle on). Once the vehicle is on, the user initiates the user request via a user channel and electronic device 160 (e.g., a smart phone).

The user request is sent to the backend server 155 via the network 150. The backend server 155 then generates one or more random vehicle signal questions and pushes them to the electronic device 160 via the network 150. These questions are related to real-time variable vehicle signals which are shown on the vehicle displays 130. Because the vehicle signals are variable (e.g., odometer reading) and unique to that vehicle at the given time, they provide the ability to authenticate with information that would only be available to a user with vehicle access and physical presence. Alternatively, in situations where the network 150 is unavailable, the user request may be sent directly to the vehicle controller 104 via the wireless transceiver 140. The controller 104 may then generate the one or more random vehicle signal questions and push them to the electronic device 160 via the wireless transceiver 140.

In the example embodiment, the random vehicle signal questions include: (i) “what is the odometer reading?”; (ii) “what is the PSI of the left front tire?”; and (iii) “what is the current range of the vehicle?” The user then identifies the answers on the vehicle displays 130 and inputs the answers into the user channel with the electronic device 160. The electronic device 160 then sends the answers to the backend server 155 via the user channel and network 150.

The backend server 155 then packages the answers into a policy along with a unique code. The backend server 155 then sends the policy to the vehicle controller 104 via the network 150 and vehicle telematics 110. The controller 104 then locally compares the user provided answers with real-time vehicle data and identifies the answer as correct or incorrect. The controller 104 then sends a signal to the backend server 155 (via telematics 110 and network 150) indicating whether each user provided answer was correct or incorrect. Notably, the controller 104 does not send any actual vehicle data, but rather just whether the answer was correct or not. The backend server 155 then receives the answer evaluation and determines whether or not to link/associate the vehicle 102 (e.g., grant the user request) to the given function/platform based on the answer evaluation.

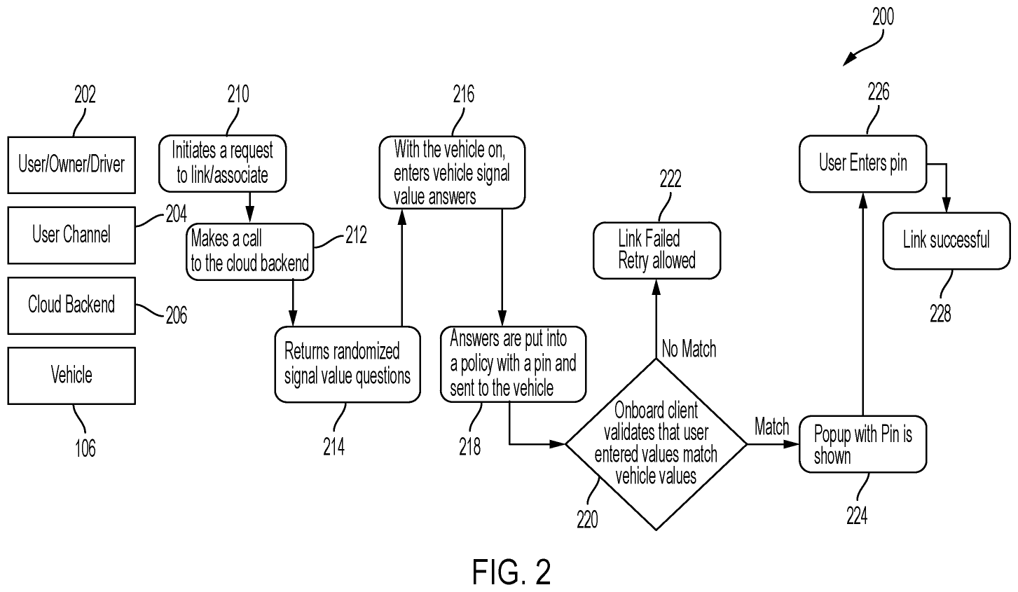

With reference now to FIG. 2, a flow diagram of an example method 200 of factor authenticating a vehicle utilizing the vehicle authentication system 100 is illustrated. The method may be performed, for example, to prove ownership/physical access to the vehicle 102 in order to link/associate the vehicle with an account or enable a vehicle feature. In the example embodiment, the actors of method 200 includes a user 202, a user channel 204, a cloud backend 206, and the vehicle 102.

The method 200 begins at step 210 where the user 202 initiates a request to link/associate the vehicle 102 for a particular predefined use case. At step 212, the user request is provided via the user channel 204. This may be done via the portable electronic device 160. At step 214, the request is received at the backend server 155 via the network 150, and the backend server 155 returns one or more randomized signal value questions (random vehicle signal questions).

At step 216, with the vehicle on, the user enters the vehicle signal value answers, which are sent to the backend server 155. These answers may be found on the vehicle displays 130. At step 218, the backend server 155 packages the answers into a policy with a code (e.g., a pin) and sends them to the vehicle 102 (e.g., controller 104). In one example embodiment, a policy is a set of rules, directions, etc. for performing one or more computer-implemented operations.

At step 220, an onboard client (e.g., controller 104) locally validates and compares whether the user entered answer values match the real-time vehicle values. If the user entered answer values do not match, at step 222, the link is failed and permission is not granted. The user channel 204 may allow one or more retries. However, if the user entered answer values match, at step 224, the vehicle generates a notification on display 130 with the code (from step 218). At step 226, the user 202 enters the code in the user channel 204. At step 228, entry of the correct code/pin authorizes the link/association. Control then ends.

Described herein are systems and methods to factor authenticate a vehicle and the vehicle owner without sending any vehicle data over a network. When a vehicle link or authentication is requested by a user, the user is provided with questions about the vehicle that only a person with physical access can determine, such as an odometer reading or tire PSI. These answers are sent to a backend server, which requests the vehicle to confirm the answers. If the vehicle confirms the answers are correct (without sending any vehicle information), the vehicle and user are authenticated. As such, the system provides a Connected Vehicle Factor Authentication without compromising vehicle data privacy.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A factor authentication system for a vehicle having a vehicle display, a telematics device, and a vehicle controller, the factor authentication system comprising:
a backend server configured to communicate with the vehicle and a user electronic device via a network,
wherein the backend server is configured to:
receive a request from the user electronic device to link the vehicle to a use case;
generate one or more random questions about vehicle signals that are visible on the vehicle display;
send the one or more random questions to the user electronic device;
receive, from the user electronic device, user answers to the one or more random vehicle signal questions;
send the user answers to the vehicle controller; and
receive, from the vehicle controller, confirmation that the user answers are correct based on a comparison to local vehicle data, to thereby authenticate the vehicle and authorize the link to the use case.

2. The vehicle factor authentication system of claim 1, wherein when the vehicle controller confirms the user answers, the vehicle controller sends a signal to the backend server indicating whether each of the user answers is correct or incorrect, without sending any sensitive vehicle data to the backend server.

3. The vehicle factor authentication system of claim 1, wherein the backend server sends the user answers to the vehicle controller along with a unique code.

4. The vehicle factor authentication system of claim 3, wherein if the vehicle controller confirms the user answer as correct, a notification is displayed to the user requesting the unique code.

5. The vehicle factor authentication system of claim 4, wherein the notification is displayed on the vehicle display.

6. The vehicle factor authentication system of claim 4, wherein the notification is displayed on the user electronic device.

7. The vehicle factor authentication system of claim 1, wherein the vehicle signals are at least one of (i) an odometer reading, (ii) a vehicle tire pressure, or (iii) a vehicle range.

8. The vehicle factor authentication system of claim 1, wherein the vehicle signals include all of (i) an odometer reading, (ii) a vehicle tire pressure, and (iii) a vehicle range.

9. The vehicle factor authentication system of claim 1, wherein the vehicle signals are chosen from the group: (i) a vehicle tire pressure, (ii) a battery voltage, (iii) a range to empty, (iv) an oil life, and (v) an odometer reading.

10. The vehicle factor authentication system of claim 1, wherein the vehicle signals are chosen from the group: (i) a vehicle tire pressure, (ii) a battery voltage, (iii) a high voltage battery state of charge, (iv) a total range, and (v) an odometer reading.

11. A computer-implemented method for factor authenticating a vehicle for linking to a use case, the vehicle including a vehicle display, a telematics device, and a vehicle controller having one or more processors and a non-transitory computer-readable storage medium, the method comprising:
receiving, from a user channel and at a backend server, a user request to link the vehicle to the use case;
generating, at the backend server, one or more random questions about vehicle signals that are visible on the vehicle display;
sending, by the backend server, the one or more random vehicle signal questions to the user channel;
receiving, from the user channel and at the backend server, user provided answers to the one or more random vehicle signal questions;
sending, from the backend server, the user provided answers to the vehicle controller; and
validating the user provided answers, by the vehicle controller, based on a comparison to local vehicle data, to thereby authenticate the vehicle and link to the use case.

12. The method of claim 11, further comprising:
wherein when the vehicle controller validates the user provided answers, the vehicle controller sends a signal to the backend server indicating whether each of the user answers is correct or incorrect, without sending any sensitive vehicle data to the backend server.

13. The method of claim 11, further comprising:
sending, by the backend server, a unique code with the user provided answers.

14. The method of claim 13, further comprising:
displaying, by the vehicle controller or the backend server, a notification requesting the unique code.

15. The method of claim 14, wherein the notification is displayed on the vehicle display by the vehicle controller.

16. The method of claim 14, wherein the notification is displayed on the user channel based on a signal from the backend server.

17. The method of claim 11, wherein the vehicle signals are at least one of (i) an odometer reading, (ii) a vehicle tire pressure, or (iii) a vehicle range.

18. The method of claim 11, wherein the vehicle signals include all of (i) an odometer reading, (ii) a vehicle tire pressure, and (iii) a vehicle range.

19. The method of claim 11, wherein the vehicle must be on in order to initiate the vehicle factor authentication system.
